(19) United States
(12) Patent Application Publication
(10) Pub. No.: US 2008/0049635 A1
(43) Pub. Date: Feb. 28, 2008

(54) Method and system for determining one-way packet travel time using RTCP

(75) Inventors: Alexander Huang, Austin, TX (US); Wallace Smith, Sea Girt, NJ (US); James James, Farmingdale, NJ (US)

Correspondence Address: TOLER LAW GROUP, 8500 BLUFFSTONE COVE, SUITE A201, AUSTIN, TX, 78759, US

(73) Assignee: SBC Knowledge Ventures, LP, Reno, NV (US)

(21) Appl. No.: 11/510,852

(22) Filed: Aug. 25, 2006

(51) Int. Cl. H04J 1/16

(52) U.S. Cl. 370/252; 370/395.52

(57) ABSTRACT

A method of measuring a one-way packet travel time from a first communication system to a second communication system comprises receiving a Real-time Transport Control Protocol (RTCP) packet outputted by the second communication system. A Network Time Protocol (NTP) timestamp value is extracted from the RTCP packet, and a time value, T, is determined based on the NTP timestamp value. A Last Sender Report (LSR) value and a Delay since LSR (DLSR) value are extracted from the RTCP packet. A value L=T−LSR−DLSR is determined to measure the one-way packet travel time from the first communication system to the second communication system.

### FIELD OF THE DISCLOSURE

The present disclosure is generally related to methods and systems for determining a one-way packet travel time.

### BACKGROUND

In some telecommunication applications, a Real-time Transport Protocol (RTP) is used to transport real-time data over an Internet Protocol (IP) network. In these and other applications, the performance of the IP network in transporting packets of real-time data is of importance. Various metrics of the performance may be monitored to ensure that the performance is desirable. Performance metrics that are determined using a Real-time Transport Control Protocol (RTCP), which is a companion protocol of RTP, include a packet loss

rate, a round-trip packet travel time (i.e. a round-trip delay or round-trip latency), and a delay variation (i.e. jitter).

One-way travel time is another performance metric that is of interest when the network exhibits asymmetrical latencies, i.e. when transport times between two communicating systems across the network differ based on a direction of transport.

### BRIEF DESCRIPTION OF THE DRAWINGS

FIG. 1 is a block diagram of an embodiment of a system for measuring one-way packet travel times using RTCP;

FIG. 2 is a flow chart of an embodiment of a method of measuring one-way packet travel times using RTCP; and

FIG. 3 is a block diagram of an illustrative embodiment of a general computer system.

### DETAILED DESCRIPTION OF THE DRAWINGS

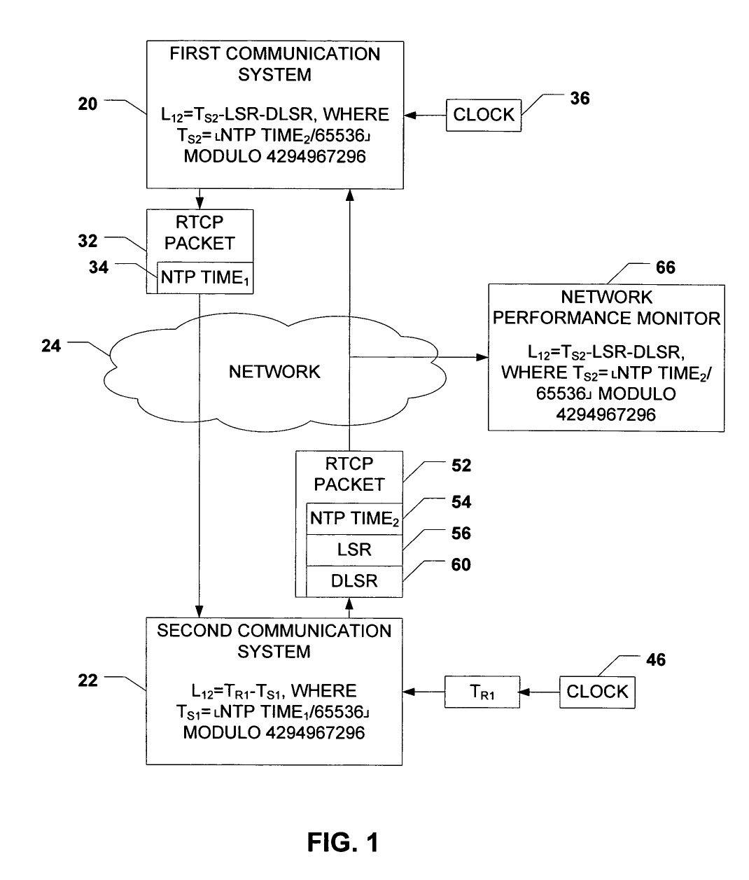

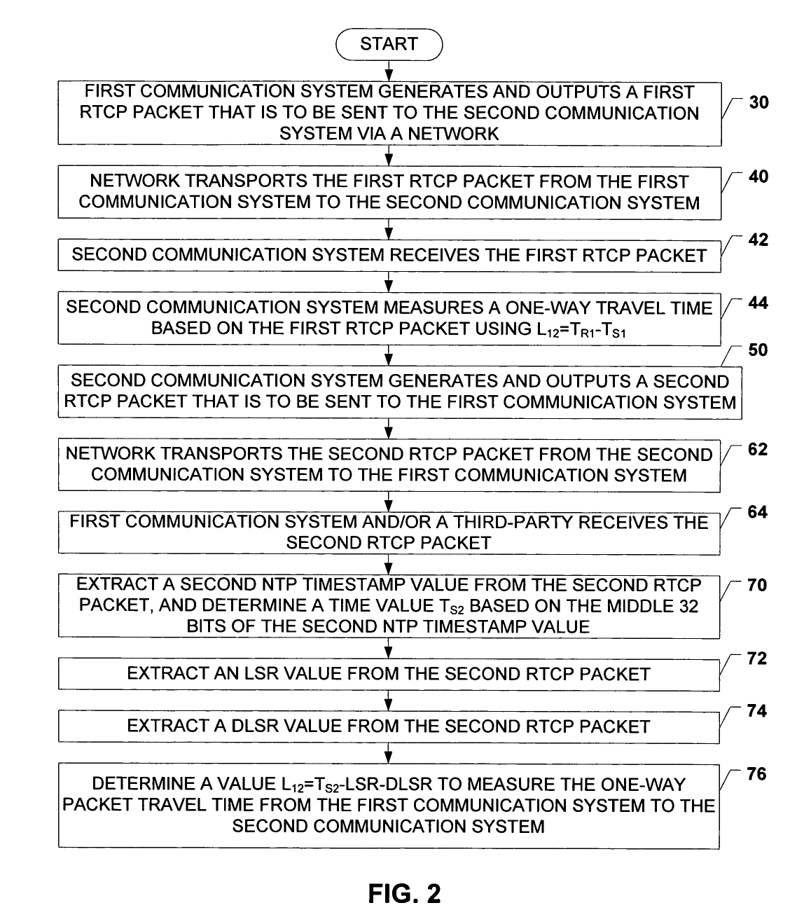

Disclosed herein are embodiments of methods and systems to monitor one-way travel time (also known as one-way delay or one-way latency) of real-time packet transport using RTCP. Embodiments are described with reference to FIG. 1, which is a block diagram of an embodiment of a system for measuring one-way packet travel times using RTCP, and FIG. 2, which is a flow chart of an embodiment of a method of measuring one-way packet travel times using RTCP.

The one-way packet travel times are determined for real-time packet communications between a first communication system 20 and a second communication system 22 via a network 24. The network 24, in general, may exhibit asymmetric latencies such that a one-way travel time for a packet traveling from the first communication system 20 to the second communication system 22 differs from a one-way travel time for a packet traveling from the second communication system 22 to the first communication system 20. The network 24 may comprise an IP network, for example. Communications between the first communication system 20 and the second communication system 22 may be in accordance with RTP and RTCP.

As indicated by block 30, the method comprises the first communication system 20 generating and outputting a first RTCP packet 32 that is to be sent to the second communication system 22. The first RTCP packet 32 comprises a first Network Time Protocol (NTP) timestamp parameter 34 that indicates a time that the first RTCP packet 32 is generated. The first NTP timestamp parameter 34 is a 64-bit value generated according to a first clock 36 of the first communication system 20.

As indicated by block 40, the method comprises transporting the first RTCP packet 32 from the first communication system 20 to the second communication system 22 via the network 24. A first one-way travel time is exhibited for transporting the first RTCP packet 32 from the first communication system 20 to the second communication system 22 via the network 24.

As indicated by block 42, the method comprises the second communication system 22 receiving the first RTCP packet 32. A receiver of the second communication system 22 receives the first RTCP packet 32 via the network 24.

As indicated by block 44, the second communication system 22 can measure the first one-way travel time based on the first RTCP packet 32. The second communication system 22 uses a second clock 46 to determine a time T_{R1} at which the second communication system 22 receives the first RTCP packet 32. Preferably, the second clock 46 is either synchronized or substantially synchronized with the first clock 36. The second communication system 22 extracts the first NTP timestamp parameter 34 from the first RTCP packet and determines a time value T_{S1} equal to a middle 32 bits of the 64-bit NTP timestamp parameter 34. The middle 32 bits of a value V represented in a 64-bit unsigned integer form may be determined by └V/65536┘ modulo 4294967296. The second communication system 22 determines a value L₁₂ equal to T_{R1}−T_{S1} to provide a measurement of the first one-way travel time. A processor of the second communication system 22 may be used to determine the first one-way travel time based on the first RTCP packet 32.

As indicated by block 50, the method comprises the second communication system 22 generating and outputting a second RTCP packet 52 that is to be sent to the first communication system 20. The second RTCP packet 52 is generated at least partially based on the first RTCP packet 32. The second RTCP packet 52 comprises a second NTP timestamp parameter 54 that indicates a time that the second RTCP packet 52 is generated. The second NTP timestamp parameter 54 is a 64-bit value generated according to the second clock 46 of the second communication system 22. The second RTCP packet 52 further comprises a Last Sender Report (LSR) value 56 that is equal to the T_{S1} value, i.e. the middle 32-bits of the first NTP timestamp value 34. The second RTCP packet 52 further comprises a Delay since LSR (DLSR) value 60. The DLSR value 60, which is the delay between receiving the first RTCP packet 32 and generating the second RTCP packet 52, is generated according to the second clock 46.

As indicated by block 62, the method comprises transporting the second RTCP packet 52 from the second communication system 22 to the first communication system 20 via the network 24. A second one-way travel time, which may differ from the first one-way travel time, is exhibited for transporting the second RTCP packet 52 from the second communication system 22 to the first communication system 20 via the network 24.

As indicated by block 64, the method comprises receiving the second RTCP packet 52 outputted by the second communication system 22. The second RTCP packet 52 is received by a receiver of the first communication system 20 and/or by a receiver of a network performance monitor 66. The network performance monitor 66 may be associated with a third-party that differs from a first party associated with the first communication system 20 and a second party associated with the second communication system 22. The network performance monitor 66 may receive the second RTCP packet 52 at an intermediate node of the network 24, the intermediate node being in a communication path between the second communication system 22 and the first communication system 20. Alternatively, the network performance monitor 66 may receive the second RTCP packet 52, as a copy or an abstract from the second communication system 22, at a node that is not in the communication path between the second communication system 22 and the first communication system 20.

A processor of the first communication system 20 and/or a processor of the network performance monitor 66 can use the second RTCP packet 52 to determine a measure of the first one-way delay time as follows. As indicated by block 70, the method comprises extracting the second NTP timestamp value 54 from the second RTCP packet 52, and determining a time value, T_{S2}, equal to or otherwise based on a middle 32 bits of the second NTP timestamp value 54. As indicated by block 72, the method comprises extracting the LSR value 56 from the second RTCP packet 52. As indicated by block 74, the method comprises extracting the DLSR value 60 from the second RTCP packet 52. As indicated by block 76, the method comprises determining a value L₁₂=T_{S2}−LSR−DLSR to measure the one-way packet travel time from the first communication system 20 to the second communication system 22.

The one-way packet travel time value can be stored, processed, outputted (e.g. displayed, printed, or communicated to another device) or any combination thereof for use in monitoring operation of the network 24. Based on the one-way packet travel time, the network performance monitor 66 or another node can tune the network 24 to improve its performance in transporting packets. Further, the network performance monitor 66 can use the one-way packet travel time to predict and/or correct undesirable conditions in the network 24.

Thus, a measure of one-way packet travel time of a packet sent by the first party can be determined by either the first party, the second party, or a third party to which the RTCP from the second party is made available. The first party and the third party use the same equation to measure the first one-way packet travel time, but the second party uses a different equation to measure the first one-way packet travel time. The accuracy of the value L₁₂ to the actual one-way packet travel time is based on how well the first clock 36 and the second clock 46 are synchronized. The one-way packet travel time can be determined without injecting testing traffic, imposing additional function to transient nodes, or assuming a symmetrical roundtrip delay.

Those having ordinary skill will recognize that the aforementioned acts can be modified to determine the second one-way packet travel time from the second communication system 22 to the first communication system 20.

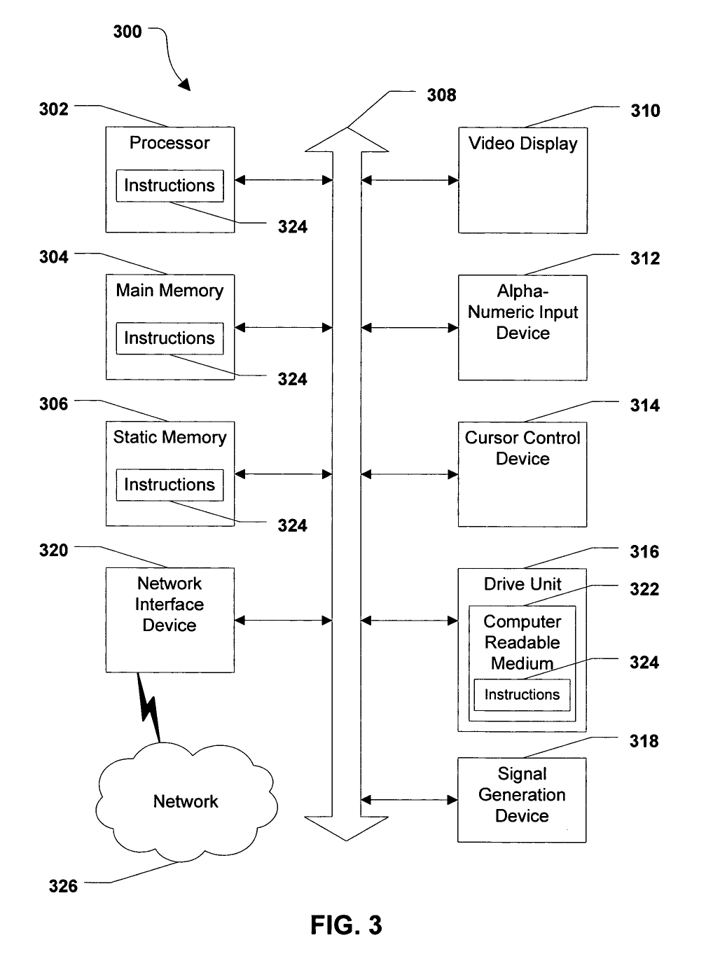

Referring to FIG. 3, an illustrative embodiment of a general computer system is shown and is designated 300. The computer system 300 can include a set of instructions that can be executed to cause the computer system 300 to perform any one or more of the methods or computer based functions disclosed herein. The computer system 300 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 300 can be implemented using electronic devices that provide voice, video or data communication. Further, while a single computer system 300 is illustrated, the term “system” shall also be taken to include any collection of systems or sub-systems that individually or jointly execute a set, or multiple sets, of instructions to perform one or more computer functions.

As illustrated in FIG. 3, the computer system 300 may include a processor 302, e.g., a central processing unit (CPU), a graphics processing unit (GPU), or both. Moreover, the computer system 300 can include a main memory 304 and a static memory 306, that can communicate with each other via a bus 308. As shown, the computer system 300 may further include a video display unit 310, such as a liquid crystal display (LCD), an organic light emitting diode (OLED), a flat panel display, a solid state display, or a cathode ray tube (CRT). Additionally, the computer system 300 may include an input device 312, such as a keyboard, and a cursor control device 314, such as a mouse. The computer system 300 can also include a disk drive unit 316, a signal generation device 318, such as a speaker or remote control, and a network interface device 320.

In a particular embodiment, as depicted in FIG. 3, the disk drive unit 316 may include a computer-readable medium 322 in which one or more sets of instructions 324, e.g. software, can be embedded. Further, the instructions 324 may embody one or more of the methods or logic as described herein. In a particular embodiment, the instructions 324 may reside completely, or at least partially, within the main memory 304, the static memory 306, and/or within the processor 302 during execution by the computer system 300. The main memory 304 and the processor 302 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 324 or receives and executes instructions 324 responsive to a propagated signal, so that a device connected to a network 326 can communicate voice, video or data over the network 326. Further, the instructions 324 may be transmitted or received over the network 326 via the network interface device 320.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of measuring a one-way packet travel time from a first communication system to a second communication system, the method comprising:
receiving a Real-time Transport Control Protocol (RTCP) packet outputted by the second communication system;
extracting a Network Time Protocol (NTP) timestamp value from the RTCP packet;
determining a time value, T, based on the NTP timestamp value;
extracting a Last Sender Report (LSR) value from the RTCP packet;
extracting a Delay since LSR (DLSR) value from the RTCP packet; and
determining a value L=T−LSR−DLSR to measure the one-way packet travel time from the first communication system to the second communication system.

2. The method of claim 1 further comprising outputting the value L.

3. The method of claim 1 further comprising tuning a network based on the value L.

4. The method of claim 1 wherein the RTCP packet is outputted by the second communication system based on a previous RTCP packet that was sent from the first communication system to the second communication system

5. The method of claim 1 wherein the RTCP packet is to be sent to the first communication system.

6. The method of claim 1 wherein the first communication system is associated with a first party, wherein the second communication system is associated with a second party, and wherein said determining the value L=T−LSR−DLSR is performed by a third party other than the first party and the second party.

7. The method of claim 1 wherein said determining the value L=T−LSR−DLSR is performed by the first communication system.

8. The method of claim 1 wherein said receiving the RTCP packet is at a node that is not in a communication path between the second communication system and the first communication system.

9. The method of claim 1 wherein the time value, T, is determined based on a middle 32 bits of the NTP timestamp value.

10. A system for measuring a one-way packet travel time from a first communication system to a second communication system, the system comprising:
a receiver to receive a Real-time Transport Control Protocol (RTCP) packet outputted by the second communication system; and
a processor to extract a Network Time Protocol (NTP) timestamp value from the RTCP packet, the processor to determine a time value, T, based on the NTP timestamp value, the processor to extract a Last Sender Report (LSR) value from the RTCP packet, the processor to extract a Delay since LSR (DLSR) value from the RTCP packet, and the processor to determine a value L=T−LSR−DLSR to measure the one-way packet travel time from the first communication system to the second communication system.

11. The system of claim 10 wherein the RTCP packet is outputted by the second communication system based on a previous RTCP packet that was sent from the first communication system to the second communication system

12. The system of claim 10 wherein the RTCP packet is to be sent to the first communication system.

13. The system of claim 10 wherein the time value, T, is determined based on a middle 32 bits of the NTP timestamp value.

14. A computer-readable medium having computer-readable program code to cause a computer system to measure a one-way packet travel time from a first communication system to a second communication system by performing acts of:
receiving a Real-time Transport Control Protocol (RTCP) packet outputted by the second communication system;
extracting a Network Time Protocol (NTP) timestamp value from the RTCP packet;
determining a time value, T, based on the NTP timestamp value;
extracting a Last Sender Report (LSR) value from the RTCP packet;
extracting a Delay since LSR (DLSR) value from the RTCP packet; and
determining a value L=T−LSR−DLSR to measure the one-way packet travel time from the first communication system to the second communication system.

15. The computer-readable medium of claim 14 wherein the RTCP packet is outputted by the second communication system based on a previous RTCP packet that was sent from the first communication system to the second communication system

16. The computer-readable medium of claim 14 wherein the RTCP packet is to be sent to the first communication system.

17. The computer-readable medium of claim 14 wherein the first communication system is associated with a first party, wherein the second communication system is associated with a second party, and wherein said determining the value L=T−LSR−DLSR is performed by a third party other than the first party and the second party.

18. The computer-readable medium of claim 14 wherein said determining the value L=T−LSR−DLSR is performed by the first communication system.

19. The computer-readable medium of claim 14 wherein said receiving the RTCP packet is at a node that is not in a communication path between the second communication system and the first communication system.

20. The computer-readable medium of claim 14 wherein the time value, T, is determined based on a middle 32 bits of the NTP timestamp value.
